(19) United States
(12) Patent Application Publication
(10) Pub. No.: US 2019/0340586 A1
(43) Pub. Date: Nov. 7, 2019

(54) CONDUCTING OPTIMIZED CROSS-BLOCKCHAIN CURRENCY TRANSACTIONS USING MACHINE LEARNING

(71) Applicant: Smart Worldwide Financial Technology, Milpitas, CA (US)

(72) Inventors: Xinxin Sheng, Seattle, WA (US); Alex Witt, Milpitas, CA (US); Bo Lan, Milpitas, CA (US)

(21) Appl. No.: 15/971,505

(22) Filed: May 4, 2018

(51) Int. Cl. G06Q 20/06; G06N 99/00; G06Q 20/36

(52) U.S. Cl. CPC G06Q 20/065; G06Q 20/367; G06N 99/005

(57) ABSTRACT

Methods and apparatuses are described for conducting cross-blockchain currency transactions. A server receives, from a client device, a request for a conversion of an amount of a first currency to an amount of a second currency. The amount of the first currency is stored in an electronic wallet associated with a user of the client device. The server determines one or more sequences of currency transactions executable that achieves the conversion from the amount of the first currency to the amount of the second currency, the one or more sequences of currency transactions comprising converting between cryptocurrencies operating on different blockchains. The server identifies one of the one or more sequences of currency transactions associated with an optimal value. The server executes the identified sequence of currency transactions associated with the optimal value.

### TECHNICAL FIELD

This application relates generally to methods and apparatuses, including computer program products, for conducting optimized cross-blockchain currency transactions using machine learning.

### BACKGROUND

In recent years, the use and exchange of cryptocurrency in financial transactions has become more common. Cryptocurrency is generally defined as a digital or virtual currency that uses encryption to manage the creation of new units, to verify transfers of assets, and to secure transactions. Exemplary cryptocurrencies include, but are not limited to, Bitcoin (BTC), Etherium (ETH), and Ripple (XRP)—although there are many others. Most, if not all, cryptocurrencies are based upon a decentralized framework, operating independently of a central bank or other authority (e.g., governmental entity)—in contrast to fiat currencies. To achieve its decentralized nature, control and management of a cryptocurrency is typically based upon blockchain technology.

A blockchain is a decentralized, public ledger of all transactions involving the associated cryptocurrency. Generally, the most recent valid transactions are added to the blockchain as a new block and linked to the previous block in the blockchain using cryptography techniques (e.g., hashing). Blockchains are typically implemented using a peer-to-peer network of disparate, independent computing devices (also called nodes) that each stores a copy of the blockchain. When a new block is created, each node receives a copy of the block and adds it to the locally-stored blockchain to maintain consistency of the blockchain across the entire network. Also, although the example provided herein involves cryptocurrency, it should be appreciated that the use of blockchains is not limited to cryptocurrencies; other applications of blockchain technology to transaction-based systems (e.g., contracts, real estate, manufacturing and distribution) are becoming prevalent.

As the number of cryptocurrencies has grown, the desire for conducting transactions between different cryptocurrencies has likewise increased. Due to this need, cryptocurrency exchange systems have sprung up which purport to enable conversion between various cryptocurrencies. However, because each cryptocurrency is built upon a different blockchain that is managed by a separate network of computing devices, it is technically challenging to conduct cross-blockchain currency trading due to the particular timing, pricing, encryption, and block generation constraints associated with each cryptocurrency.

Existing cryptocurrency exchange systems have attempted a variety of different ways to solve this problem. For example, some systems utilize atomic cross-blockchain trading techniques. In this example, Party A owns coins in a first cryptocurrency, Party B owns coins in a second cryptocurrency, and the parties wish to exchange them. In atomic trading, each party's coins are locked for a predetermined period of time (i.e., a lockout) at the initiation of the exchange and the coins are only released upon completion of the exchange. But, if Party A decides not to proceed with the trade, Party B's coins remain locked—and cannot be used—until the lockout period ends. The lockout effectively renders any exchange system impractical, particularly in high-volume, real-time currency trading.

Another example involves creating a network of blockchains (also called a chain of chains) that use a native staking token which validators must stake in order to perform work for the respective blockchains and relaying messages with synthetic tokens about the state of one blockchain to another. Examples include Polkadot and Cosmos. However, a drawback of such ‘chain of chains’ systems is that they are dependent upon, and limited to, existing relationships. Building a new chain is computationally expensive, e.g., if there are n cryptocurrencies, there need to be n*(n−1)/2 chains to provide all possible coin-to-coin exchanges—without even getting into the substantial counter-party risk involved.

Another example relates to using a specialized chain to conduct cross-blockchain trading (i.e., copying a portion of one cryptocurrency blockchain into another cryptocurrency blockchain as ‘proof’ that a transaction in the first blockchain has occurred). For example, Party A owns coins in Cryptocurrency X, Party B owns coins in Cryptocurrency BTC, and the parties wish to exchange them. Each party has a wallet address associated with each of the respective cryptocurrencies. Party A commits to pay Coin X to Party B's address in X, with a contract that requires publication of a ‘proof’ in X within a limited time after the payment. Party B pays Coin BTC to Party A's address in BTC. Then, a portion of the BTC blockchain is copied into the X blockchain as ‘proof’ that the Coin BTC transaction occurred—at which point the contract is allowed by the X blockchain, completing the Coin X payment. Because these exchanges universally rely on BTC, the BTC blockchain acts as a bottleneck to transactions, both from a computer processing perspective and from a price perspective (e.g., if the price of BTC is very high, transactions may be prohibitive).

In addition, because existing cryptocurrency exchanges conduct transactions at the protocol layer, they typically do not have the capability to determine a market price of a particular cryptocurrency exchange at a particular time before executing the transaction. And, existing cryptocurrency exchanges lack functionality to analyze cryptocurrency pricing and market trends across multiple different exchanges to predict pricing changes for certain currencies and provide actionable information to client devices with respect to the exchange of such currencies.

### SUMMARY

Therefore, what is needed are methods and systems for implementing optimized cross-blockchain currency transactions that leverage advanced machine learning techniques—including the determination of an optimized value of various proposed currency exchanges prior to initiation of a trade, and prediction of currency price changes based upon historical and present market data. The techniques described herein provide several advantages. First, the systems and methods described herein orchestrate many different application programming interfaces (APIs) that couple the inventive system to a plurality of different cryptocurrency exchanges, in order to understand (and take advantage of) pricing opportunities that exist in the various exchanges. The systems and methods described herein also enable the ability to establish virtual exchange calculations (e.g., of a proposed transaction from Currency A to Currency B) across all different exchanges, using any number of different intermediate currencies and/or exchanges, without the original or target coin being listed in more than one place. These virtual exchange calculations can account for particular exchange fees levied by each cryptocurrency/currency, and/or exchange, to determine the optimal sequence of trades to perform that result in the best value for the overall transaction in a pre-defined timespan—irrespective of computational difficulty or the number of hops across different blockchains.

The invention, in one aspect, features a system for conducting cross-blockchain currency transactions. The system comprises a server computing device including a memory for storing programmatic instructions and a processor for executing the programmatic instructions. The system comprises a database coupled to the server computing device. The processor of the server computing device executes the programmatic instructions to receive, from a first client computing device, a request for a conversion of an amount of a first currency listed for trading on at least one of a plurality of cryptocurrency exchanges to an amount of a second currency listed for trading on at least one of the plurality of cryptocurrency exchanges. The amount of at least one of the first currency or the second currency is stored in an electronic wallet associated with a user of the first client computing device. The processor executes the programmatic instructions to determine one or more sequences of currency transactions executable between two or more of the plurality of cryptocurrency exchanges that achieves the conversion from the amount of the first currency to the amount of the second currency, at least one the one or more sequences of currency transactions comprising converting between cryptocurrencies operating on different blockchains. The processor executes the programmatic instructions to identify one of the one or more sequences of currency transactions associated with an optimal value based upon one or more of: a market price of the first currency, a market price of the second currency, a latency associated with the sequence of currency transactions, or an exchange fee associated with one or more of the currency transactions in the sequence of currency transactions. The processor executes the programmatic instructions to execute the identified sequence of currency transactions associated with the optimal value, comprising: verifying one or more data elements of the electronic wallet associated with the user of the first client computing device; withdrawing the amount of the first currency from the electronic wallet and storing the amount of the withdrawn first currency in a temporary cache of the database; issuing buy and sell orders to two or more of the plurality of cryptocurrency exchanges using the identified sequence of currency transactions to receive the amount of the second currency and storing the amount of the second currency in the temporary cache; and transmitting the amount of the second currency to an address of the electronic wallet associated with the user of the first client computing device.

The invention, in another aspect, features a computerized method of conducting cross-blockchain currency transactions. A server computing device including a memory for storing programmatic instructions and a processor for executing the programmatic instructions, that is coupled to a database, receives, from a first client computing device, a request for a conversion of an amount of a first currency listed for trading on at least one of a plurality of cryptocurrency exchanges to an amount of a second currency listed for trading on at least one of the plurality of cryptocurrency exchanges. At least one of the amount of the first currency or the second currency is stored in an electronic wallet associated with a user of the first client computing device. The server computing device determines one or more sequences of currency transactions executable between two or more of the plurality of cryptocurrency exchanges that achieves the conversion from the amount of the first currency to the amount of the second currency, at least one of the one or more sequences of currency transactions comprising converting between cryptocurrencies operating on different blockchains. The server computing device identifies one of the one or more sequences of currency transactions associated with an optimal value based upon one or more of: a market price of the first currency, a market price of the second currency, a latency associated with the sequence of currency transactions, or an exchange fee associated with one or more of the currency transactions in the sequence of currency transactions. The server computing device executes the identified sequence of currency transactions associated with the optimal value, comprising: verifying one or more data elements of the electronic wallet associated with the user of the first client computing device; withdrawing the amount of the first currency from the electronic wallet and storing the amount of the withdrawn first currency in a temporary cache of the database; issuing buy and sell orders to two or more of the plurality of cryptocurrency exchanges using the identified sequence of currency transactions to receive the amount of the second currency and storing the amount of the second currency in the temporary cache; and transmitting the amount of the second currency to an address of the electronic wallet associated with the user of the first client computing device.

Any of the above aspects can include one or more of the following features. In some embodiments, the first currency is a cryptocurrency and the second currency is a cryptocurrency. In some embodiments, the first currency is a fiat currency and the second currency is a crypto currency. In some embodiments, the first currency is a cryptocurrency and the second currency is a fiat currency. In some embodiments, the first currency is a fiat currency and the second currency is a fiat currency.

In some embodiments, determining one or more sequences of currency transactions executable between two or more of the plurality of cryptocurrency exchanges comprises: selecting a first cryptocurrency exchange of the plurality of cryptocurrency exchanges that lists the first currency for trading; selecting a second cryptocurrency exchange of the plurality of cryptocurrency exchanges that lists the second currency for trading; determining one or more intermediate cryptocurrency exchanges between the first cryptocurrency exchange and the second cryptocurrency exchange; determining one or more intermediate cryptocurrencies between the first currency and the second currency that are listed for trading on one or more of the intermediate cryptocurrency exchanges; and generating one or more sequences of currency transactions between the first cryptocurrency exchange and the second cryptocurrency exchange, at least one of the one or more sequences of currency transactions including sequences of currency transactions that involve at least one of the intermediate cryptocurrency exchanges and at least one of the intermediate cryptocurrencies.

In some embodiments, identifying one of the one or more sequences of currency transactions associated with an optimal value comprises one or more of: identifying a sequence of currency transactions that has a highest price of the first currency, identifying a sequence of currency transactions that has a highest price of the second currency, identifying a sequence of currency transactions that has a lowest exchange fee associated with one or more of the currency transactions, or identifying a sequence of currency transactions that completes within the latency. In some embodiments, verifying one or more data elements of the electronic wallet associated with the user of the first client computing device comprises validating availability of the amount of the first currency in the electronic wallet. In some embodiments, verifying one or more data elements of the electronic wallet associated with the user of the first client computing device comprises validating an identifier associated with the first client computing device. In some embodiments, the identifier is a cell phone number.

In some embodiments, withdrawing the amount of the first currency from the electronic wallet and storing the amount of the withdrawn first currency in a temporary cache of the database comprises adding a transaction entry to a blockchain associated with the first currency, the transaction comprising the amount of the first currency and an address of the electronic wallet. In some embodiments, transmitting the amount of the second currency to an address of the electronic wallet associated with the user of the first client computing device comprises adding a transaction entry to a blockchain associated with the second currency, the transaction comprising the amount of the second currency and the address of the electronic wallet.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for conducting cross-blockchain currency transactions.

FIG. 2 is a flow diagram of a computerized method of conducting cross-blockchain currency transactions.

FIG. 3 is a diagram of an exemplary screenshot of a user interface on the client computing device.

FIG. 4 is a diagram of an exemplary screenshot of a user interface on the client computing device that includes a prediction notification message.

FIG. 5 is a flow diagram of a computerized method of executing an identified sequence of currency transactions.

### DETAILED DESCRIPTION

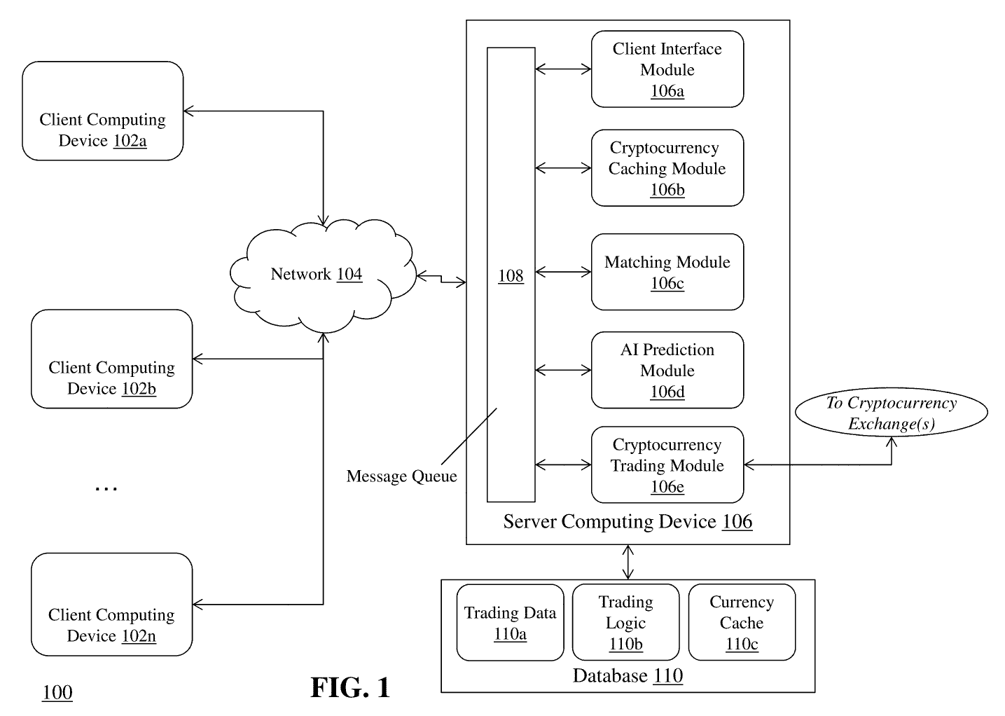

FIG. 1 is a block diagram of a system 100 for conducting cross-blockchain currency transactions. The system 100 includes a plurality of client computing devices 102a-102n that are each coupled via communications network 104 to a server computing device 106. The server computing device 106 includes a client interface module 106a, a cryptocurrency caching module 106b, a matching module 106c, an artificial intelligence (AI) prediction module 106d, and a cryptocurrency trading module 106e. The modules 106a-106e are configured to communicate using a message queue 108. The server computing device 106 is coupled to a database 110 that stores trading data 110a, trading logic 110b, and a currency cache 110c.

Exemplary client computing devices 102a-102n include, but are not limited to, tablets, smartphones, smart watches, Internet-of-Things (IoT) devices, laptops, desktops, and other computing devices. It should be appreciated that other types of client computing devices that are capable of connecting to the components of the system 100 can be used without departing from the scope of invention. It should be appreciated that the system 100 can include any number of client computing devices.

The client computing devices 102a-102n can execute software applications, such as browser applications and/or native applications. In some embodiments, a browser application comprises software executing on a processor of the client computing device 102a-102n that enables the device to communicate via HTTP or HTTPS with remote servers addressable with URLs (e.g., server computing device 106) to receive content, including one or more webpages, for rendering in the browser application and presentation on a display device embedded in or coupled to the client computing device 102a-102n. Exemplary mobile browser application software includes, but is not limited to, Firefox™, Chrome™, Safari™, and other similar software. The one or more webpages can comprise visual and audio content for display to and interaction with a user, that contain data relating to the process of conducting cross-blockchain currency transactions as described herein.

In some embodiments, a native application is a software application (also called an ‘app’) that is installed locally on the client computing device 102a-102n and written with programmatic code designed to interact with an operating system that is native to the client computing device 102a-102n. Such software is available from, e.g., the Apple® App Store or the Google® Play Store. In some embodiments, the native application includes a software development kit (SDK) module that is executed by a processor of the client computing device 102a-102n to perform functions associated with conducting cross-blockchain currency transactions as described herein.

The communications network 104 enables the other components of the system 100 to communicate with each other in order to perform the process of conducting cross-blockchain currency transactions as described herein. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The server computing device 106 is a combination of hardware, including one or more special-purpose processors and one or more physical memory modules, and specialized software modules—such as modules 106a-106e and message queue 108—that execute on the processor of the server computing device 106, to receive data from other components of the system 100, transmit data to other components of the system 100, and perform functions for conducting cross-blockchain currency transactions as described herein.

In some embodiments, the modules 106a-106e are specialized sets of computer software instructions programmed onto a dedicated processor in the server computing device 106 and can include specifically-designated memory locations and/or registers for executing the specialized computer software instructions. Further explanation of the specific processing performed by the modules 106a-106e will be provided below.

The message queue 108 is a computing process that manages inter-process communication and inter-thread communication for the modules 106a-106e. In one embodiment, the message queue is implemented using Rabbitmq available from Pivotal Software, Inc. The message queue 108 passes controlled contents in prescribed message format to specific computing modules. For example, the message queue 108 accepts trading requests and orders, issues trade execution messages, and returns trading results.

The database 110 comprises transient and/or persistent memory for data storage that is used in conjunction with the process of conducting cross-blockchain currency transactions as described herein. Generally, the database 110 is configured to receive, generate, and store specific segments of data associated with conducting cross-blockchain currency transactions. As shown in FIG. 1, the database 110 stores trading data 110a, trading logic 110b and a currency cache 110c. In some embodiments, all or a portion of the database 110 can be integrated within the server computing device 106 or be located on a separate computing device or devices. For example, the database 110 can comprise an in-memory data structure store such as Redis™, available at redis.io.

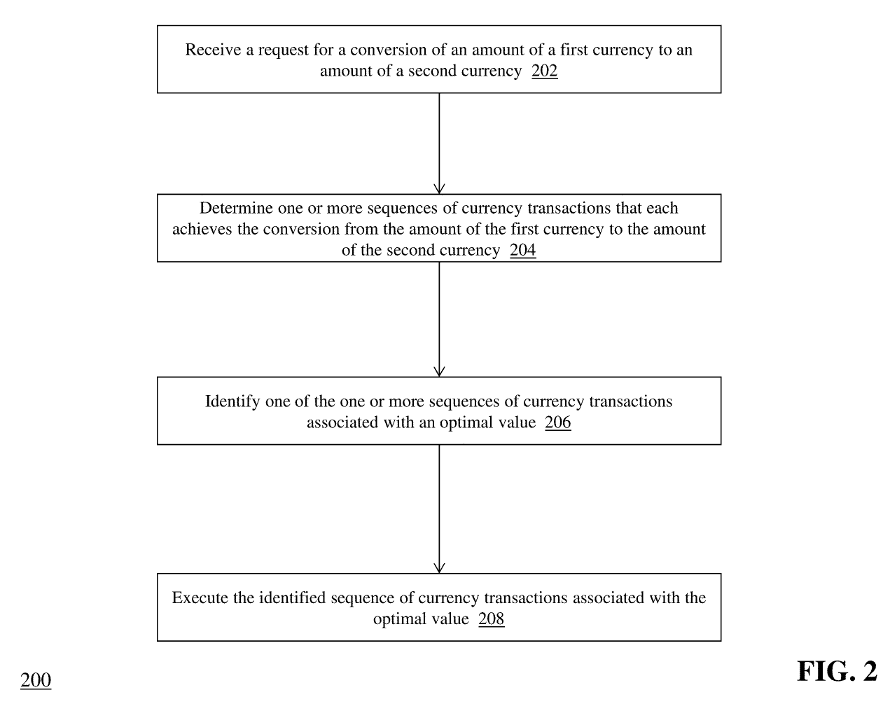

FIG. 2 is a flow diagram of a computerized method 200 of conducting cross-blockchain currency transactions, using the system 100 of FIG. 1. The client interface module 106a of server computing device 106 establishes a connection with one or more of the client computing devices 102a-102n to initiate a conversion transaction from a first currency (e.g., Cryptocurrency A) to a second currency (e.g., Cryptocurrency B). The client interface module 106a receives (202) a request for a conversion of an amount of the first currency, which is listed for trading on at least one of a plurality of cryptocurrency exchanges, to an amount of the second currency listed for trading on at least one of the plurality of cryptocurrency exchanges. For example, a user at client device 102a can launch a native application (or ‘app’) installed on the device, which establishes a network connection (e.g., TCP, HTTP, HTTPS) with the server computing device 106. The app can present a user interface on the client device 102a that enables the user to set up a proposed currency exchange transaction for submission to the server computing device 106.

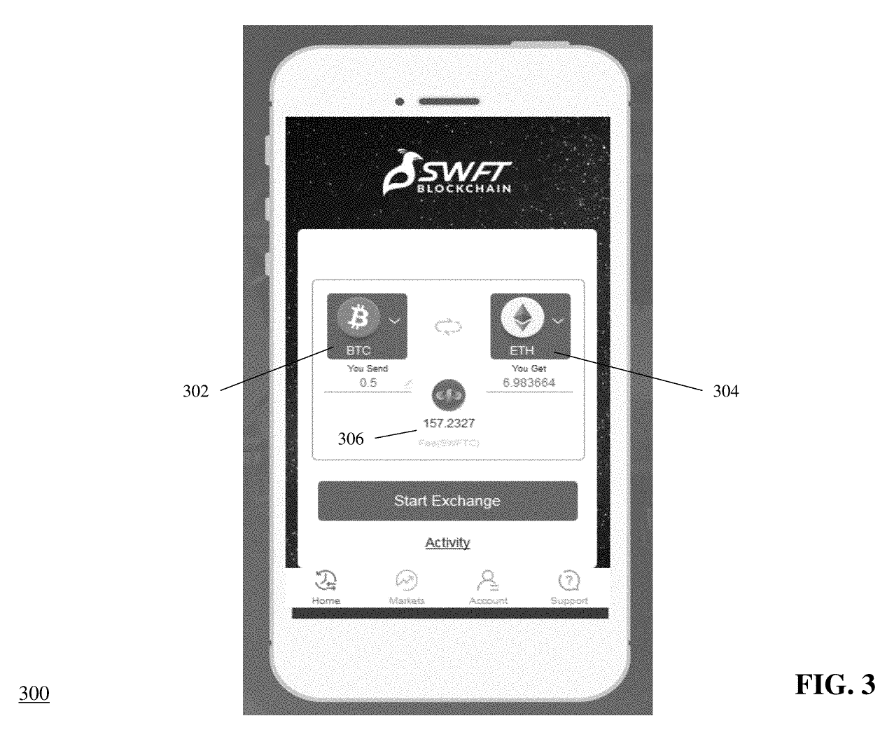

FIG. 3 is a diagram of an exemplary screenshot of a user interface 300 on the client computing device. As shown in FIG. 3, the user interface provides a first drop-down 302 box in which the user can select the currency to be withdrawn from his electronic wallet (in this case, BTC) and a second drop-down box 304 in which the user can select the currency to be received into his electronic wallet in exchange (in this case, ETH). For example, the user can maintain one electronic wallet (or multiple electronic wallets) that store information associated with transactions on different blockchains that are associated with the user's cryptocurrency balances. Generally, an electronic wallet (or digital wallet) in this context is a software program that stores public and private cryptography key pairs, which are used by exchanges to withdraw currencies from or deposit currencies to the electronic wallet. The wallet can be stored locally (e.g., on a client device) or in a centralized location (e.g., on a remote server, cloud infrastructure, wallet provider, etc.). A wallet can also be backed up to ensure security of the wallet, typically via an encrypted file that contains all of the private keys.

In one example, to withdraw funds from an electronic wallet, a computing device that executes the electronic wallet software generates a payment instruction that indicates certain information, such as: currency type, currency amount, and address of the electronic wallet to which the currency will be sent. The computing device then digitally signs the payment instruction using the private key stored in the electronic wallet—which demonstrates ownership of the currency in the electronic wallet. The computing device transmits the signed payment instruction to any of the other computing devices (i.e., a validator node) that comprise the network (e.g., in a single blockchain or across blockchains). The other computing device verifies the signed payment instruction both technically and substantively. For example, each computing device analyzes the technical attributes of the payment instruction (e.g., format, message size, version numbering, and the like) to ensure that the payment instruction complies with the technical requirements of the corresponding blockchain. The other computing device also analyzes the substantive attributes of the payment instruction (e.g., is the destination address valid?, does the wallet have enough currency to make the payment?, has the currency already been spent?) to ensure that the payment instruction can be processed by the blockchain.

Once both sets of tests noted above are complete and confirmed, the other computing device forwards the payment instruction to all of the other computing devices in the blockchain—and each of these devices runs the same validation tests as set forth above. When this phase is complete, each device stores the payment transaction in a pool of unconfirmed transactions, awaiting the addition of the next block to the blockchain in order to be confirmed.

It should be appreciated that there are both software and hardware wallets, and cryptocurrency exchanges typically link the user's wallet to their centrally managed wallet(s). When trading cryptocurrencies between users on an exchange, the trades are written in the exchange's private ledger (i.e., an off-chain transaction). Off-chain transactions are typically used by most exchanges; however, this exposes the exchanges to significant security risks (e.g., if the exchanges are hacked or otherwise compromised, it can result in the loss or theft of users' asset balances). Only when a user wants to transfer new cryptocurrency into the exchange, or when the user wants to take cryptocurrency out of the exchange, is the transaction is written onto the public blockchain (i.e., an on-chain transaction). In some instances, the use of an electronic wallet carries the risk of loss as the private keys can be copied and used without the wallet owner's consent. The systems and methods described herein beneficially conduct on-chain cryptocurrency trades across blockchains to avoid the potential security risks outlined above.

Continuing with FIG. 3, the user can enter an amount of the first currency to be withdrawn (e.g., 0.5 BTC) and the app communicates with the cryptocurrency trading module 106e to determine a corresponding amount of the second currency to be received in exchange (e.g., 6.983664 ETH). In some embodiments, to execute the exchange, a transfer fee may be required (in this case, 157.2337 SWFTC, or SWFTCoin); the user interface displays the transfer fee amount 306 to the user.

In order to determine the amount of the second currency to be received in the transaction, the server computing device 106 executes trading logic 110b stored in database 110 and uses trading data 110a also stored in database 110 to determine (204) one or more sequences of currency transactions executable between two or more of the plurality of cryptocurrency exchanges that achieve the conversion from the amount of the first currency to the amount of the second currency. In some embodiments, the one or more sequences of currency transactions can comprise one or more transactions that convert between cryptocurrencies operating on different blockchains (e.g., BTC→ETH).

It should be appreciated that the techniques described herein are applicable to fiat currency exchanges (e.g., USD→GBP) as well, including cross-border currency transactions. For example, if a user wants to transfer USD to GBP using the present system, the system 100 can sell USD and buy a cryptocurrency (e.g., BTC) on a US-based exchange, then sell the BTC and buy GBP on a British-based exchange. The advantage provided by the systems and methods described herein is that the system automatically identifies the series of currency transactions (including which exchanges and/or cryptocurrencies to use based upon price, cost, latency and the like) to obtain an optimal value for the transaction.

In order to determine the sequences of currency transactions that achieve the desired conversion, the cryptocurrency trading module 106e connects to a plurality of different cryptocurrency exchanges (as shown in FIG. 1) and uses instructions stored in the trading logic 110b to retrieve pricing and order information from each of the cryptocurrency exchanges. In some embodiments, the cryptocurrency trading module 106e establishes a connection with each of the cryptocurrency exchanges and issues periodic HTTPS requests to the exchanges for market information about the various cryptocurrencies that are being traded on the exchanges. Because different exchanges typically have different connection mechanisms, the cryptocurrency trading module 106e advantageously encapsulates the different connection mechanisms into a reusable, exchange-agnostic framework that can be called for any exchange.

The following is an example of Python programming code used by the module 106e to get an order book for a cryptocurrency exchange:

```
@abstractmethod
def get_orders(self, market):
    “““
        Get orderbook for the target market
        :param market: the target market, e.g. ‘eth_btc’
        :return orderbook in the following format:
            {
                ‘result’: True,
                ‘asks’:[[0.0465644, 0.00717], [0.0466, 0.3]],
                ‘bids’:[[0.04656463, 63], [0.04555, 2]]
            }
            The ‘‘‘asks’’’ are sorted in ascending order
            The ‘‘‘bids’’’ are sorted in descending order
    ”””
    raise NotImplementedError( )
```

As shown above, the get_orders method returns an order book (in the orderbook parameter) from a cryptocurrency exchange for a particular market (defined in the market parameter). The order book comprises a list of asks (or asking prices) and a list of bids (or bidding prices) for each currency in the market. The cryptocurrency trading module 106e stores the order book information returned by the above function in the database 110. The cryptocurrency trading module 106e can obtain order book information for any number of different cryptocurrencies and exchanges, depending upon the type of currencies listed for trading on the exchanges (as some exchanges may not list specific currencies). In some embodiments, the cryptocurrency trading module 106e receives real-time order book information from the cryptocurrency exchanges.

Next, the cryptocurrency trading module 106e determines possible sequences of currency transactions (or trading paths) for the currencies defined in the request that was received from the client computing device 102a. For example, if the user wants to exchange BTC→ETH, the cryptocurrency trading module 106e can analyze the order book information to determine any of a number of trading paths within and/or between two or more cryptocurrency exchanges that will result in the desired transaction, e.g.:

BTC_{Exchange1}→ETH_{Exchange1}

BTC_{Exchange2}→LTC_{Exchange2}→ETH_{Exchange3}

BTC_{Exchange4}→LTC_{Exchange5}→BCH_{Exchange6}→ETH_{Exchange2}

Note that the above sequences of currency transactions are exemplary available paths that the cryptocurrency trading module 106e can use to effect the conversion. Theoretically, there may be a high number, or even unlimited number, of paths. Pragmatically, each additional hop adds an extra delay and an extra layer of transaction fees. Thus, in one embodiment the cryptocurrency trading module 106e starts with, e.g., the most financially feasible routes from previous transactions, and keeps searching for a better route until a pre-defined timeout. In other words, the cryptocurrency trading module 106e can look for pragmatic “local optimal,” not “global optimal,” which usually does not exist. Generally, there will typically be one sequence that can be considered the ‘best’ or ‘optimal’ sequence based upon certain defined characteristics such as price of the first currency, price of the second currency, latency of the transaction, and/or the amount and number of exchange fees required (as each transaction in the sequence may be subject to a separate exchange fee). The cryptocurrency trading module 106e identifies (206) one of the one or more sequences of currency transactions associated with an optimal value based upon one or more of: a market price of the first currency, a market price of the second currency, an exchange fee associated with one or more of the currency transactions in the sequence of currency transactions, or a latency associated with the sequence of currency transactions. For example, it may be preferable to execute a sequence of currency transactions with a lower latency to take advantage of specific pricing or timing constraints, instead of a sequence with a higher latency that may not execute within enough time to achieve the specific pricing or timing constraints.

Also, it should be appreciated that in some cases, an over-the-counter (OTC) trade may be optimal due to saved transaction time. Depending on the implementation, a blockchain transaction may take seconds to minutes to confirm. In some embodiments, the cryptocurrency caching module 106b stores frequently traded currencies in currency cache 110c in the database 110 to speed up certain conversions. For example, when one user is selling and the other user is buying the same coin, the matching module 106c matches the seller and buyer to consummate partial OTC transactions, which saves on time and transaction fees. The flexibility enables immediate transactions with multiple sellers/buyers involved.

As an example, suppose Seller A sells BTC in the amount of x, Buyer B buys BTC in the amount of y. The matching module 106c matches Seller A and B to form a pair. Suppose x<y, the overlapping amount is z. Upon trading confirmation using the cryptocurrency trading module 106e as described herein, the module 106e deposits z BTC into Buyer B's electronic wallet immediately. For Seller A, the order is fulfilled right away. For Buyer B, a partial order is fulfilled right away and partial funds are available right away.

The subsequent order of buying BTC with the amount difference of |y−x| may be fulfilled by the cryptocurrency trading module 106e or in a very short predefined time span, if Seller C wants to sell BTC in the amount of m, where m>(y−x), then the rest of Seller B's order is fulfilled OTC as well.

Therefore, the cryptocurrency caching module 106b maintains the currency cache 110c of, e.g., the most frequently traded coins to facilitate trading speed. A large percentage of trades are OTC trades.

To identify the sequence of currency transactions with the optimal value, the cryptocurrency trading module 106e—in conjunction with the AI prediction module 106d—can execute advanced machine learning algorithms and data processing techniques that generate predictions of cryptocurrency price changes within and/or across the connected exchanges. The module 106e can then utilize the predicted price changes relating to particular currencies in determining the best sequence of transactions for a particular conversion requested by a user (e.g., BTC is expected to increase in price during the next 30 minutes, so the module 106e may select a sequence of transactions that accounts for the expected increase—such as a sequence that does not use BTC as an intermediary coin—to provide a better value for the conversion). In a related manner, the server computing device 106 can generate notification messages that describe the predictions generated by the cryptocurrency trading module 106e and AI prediction module 106d for transmission to the client computing devices 102a-102n as actionable information for the user. Both uses of the machine learning price prediction data will be described below.

The AI prediction module 106d incorporates a machine learning model that is trained using specific machine learning algorithms on a set of sampled training data, which is culled from the trading data 110a captured by the cryptocurrency trading module 106e. Once trained, the machine learning model is validated using a set of test data to confirm that the price predictions generated by the model are not erroneous. Then, the AI prediction module 106d can use the trained machine learning model to generate predictions of future price changes for specific currencies and/or cryptocurrencies.

Generally, the system 100 described herein leverages machine learning techniques to more efficiently monitor the order book cache and the trading pool, so that optimal cryptocurrency trading routes and price predictions can be discovered. Specifically, for a certain trading pair (e.g., BTC→ETH), the AI prediction module 106d focuses on two tasks:

1. Predict trading volume tendency thirty minutes from the current time;

2. Predict price gap changes between any two cryptocurrency exchanges thirty minutes from the current time.

An expectation is that large trading volume and price gap may lead to frequent trading demands (e.g. if there is a relatively large gap between two exchanges for BTC→ETH and the gap is expected to last for some time, it is predictable that users will utilize the gaps for arbitrage.) If that situation happens (or will happen), the AI prediction module 106d needs to increase the update frequency for the order book cache, providing user and the cryptocurrency trading module 106e with up-to-date data.

The AI prediction module 106d tracks and records key indicators as inputs to the prediction process. Such key indicators include (but are not limited to):
1-min K-lines in 30 minutes (open, close, high, low, volume) (also called K-line patterns, typically used in time series for predictive modeling as described in Tao et al., “K-Line Patterns' Predictive Power Analysis Using the Methods of Similarity Match and Clustering,” Mathematical Problems in Engineering, Vol. 2017, Article ID 3096917, available at www.hindawi.com/journals/mpe/2017/3096917, which is incorporated herein by reference);
5-min K-lines in 30 minutes;
10-min K-lines in 30 minutes;
traditional indicators: stop and reverse (SAR), exponential moving average (EMA), relative strength index (RSI) in 30 minutes, based on the corresponding K-lines;
custom indicators: order book depth, average trading volume in past 30 minutes.

It should be appreciated that, different from other types of data trending and data sampling analysis, trading data is time sensitive—so events suggestive of price changes in the distant past may not be indicative of anticipated price changes going forward. For example, because the use and trading of cryptocurrency is so new, trading data over six months old is typically not applicable to predictions of near-term cryptocurrency price changes. As a result, the AI prediction module 106d can only use a small amount of cryptocurrency trading data to train and test its machine learning model—which requires the use of unexpected techniques to ensure that the machine learning model generates valid predictions. The following paragraphs described these techniques in detail.

### K-Fold Cross-Validation

In the machine learning context, there are many possible ways to split trading data into training data and test data. In some embodiments, the AI prediction module 106d uses k-fold cross-validation, where the original trading data sample is randomly partitioned into k equal-sized subsamples. Of the k subsamples, a single subsample is retained as the validation data for testing the model, and the remaining k−1 subsamples are used as training data.

In some embodiments, the trading data being analyzed include trading events and cryptocurrency market snapshots. Trading events include trading history highlights, such as (but not limited to) acute rising and dropping of the prices, acute increase and decrease of trading volume, network congestion metrics (for example, blockchain network congestion slows down trading confirmation by slowing down the voting process), and forking plans.

A market snapshot is the market situation at one particular timestamp, including a large volume of cryptocurrencies that are being traded, their prices at the timestamp, and their trending description (e.g., +5%, or −3% over a predefined period of time 24 hours, 7 days, etc.). In some embodiments, AI prediction module 106d determines which cryptocurrency to select based upon Monte-Carlo sub-sampling, which selects a large group out of all currencies, but randomly drops some. A similar mechanism is used in neural network processing to prevent overfitting (for example, as described in N. Srivastava et al., “Dropout: A Simple Way to Prevent Neural Networks from Overfitting,” Journal of Machine Learning Research 15 (2014), pp. 1929-1958, which is incorporated herein by reference).

In one embodiment, a series of market snapshots are used as the training data. The AI prediction module 106d can capture a market snapshot every minute, and accumulates 525,600 snapshots a year for training. The AI prediction module 106d keeps a revolving window of the snapshots, replacing the oldest one with the newest one as time goes by. So the training data and the test data are constantly being updated to improve the machine learning model. Given the limited number of snapshots that are significant to trending prediction, the AI prediction module 106d uses K-fold cross validation (as mentioned above) to optimize the use of the training data.

After partitioning the training data, the AI prediction module 106d then repeats the cross-validation process k times (i.e., the folds), with each of the k subsamples used exactly once as the validation data. The k results from the folds can then be averaged to produce a single estimation. The advantage of this method over repeated Monte Carlo sub-sampling is that all observations are used for both training and validation, and each observation is used for validation exactly once.

In one embodiment, the AI prediction module 106d uses 10-fold cross-validation, as follows:

The AI prediction module 106d randomly shuffles the trading data sample into ten sets d₀, d₁, . . . , d₉. All sets are of equal size. The module 106d then trains the machine learning model on sets d₀ to d₈ and validate on d₉, followed by training the machine learning model on d₁ to d₉ and validating on do, and so on.

The goal of cross-validation is to estimate the expected level of fit of a machine learning model to a data set that is independent of the data that was used to train the model. Given the nature of price prediction, the AI prediction module 106d is handling data for time series forecasting. As such, the module 106d modifies the cross-validation procedure based on a rolling forecasting origin to allow multi-step errors to be used. The first calculation implements a one-step time series cross-validation where the drift parameter is re-estimated at every forecast origin. The second calculation estimates the drift parameter once for the whole data set, and then computes the error from the one-step forecasts.

### Data Normalization

As new trading data is captured by the system for use in generating price change predictions, the AI prediction module 106d performs a feature normalization step to standardize the range of independent variables or features of the data. For example, the most influential factors (therefore, the most weighted factors) for price change prediction are generally prices of other cryptocurrencies. However, it should be appreciated that these prices vary on scale significantly—e.g., currently, a $10 USD drop on BTC equates to approximately 0.1%, but equates to a 1% drop on ETH, and equates to a 50% drop on ETC. So, the concept of ‘absolute value’ in cryptocurrency price prediction context does not make sense. The AI prediction module 106d rescales the range of features to scale the range in [−1, 1]. Selecting the target range depends on the nature of the data. The formula is:

$${x}^{′} = \frac{x - min ( x )}{max ( x ) - min ( x )} \qquad ( 1 )$$

where x is an original value, x′ is the normalized value. In addition to individual cryptocurrency prices, the AI prediction module 106d also uses trading data elements such as total market cap, trading volume, launching of new products, and forking as factors that influence future price changes. The AI prediction module 106d quantifies and scales these factors in a similar manner.

### Linear Combination

Also, because (as indicated above) many factors may influence future price changes, the AI prediction module 106d combines factors together linearly and adjusts scalars for each factor as weights. For example, suppose that X is a vector space of influential factors x₁, x₂, . . . , xₙ and scalars a₁, a₂, . . . , aₙ—then the linear combination of those vectors with the scalars as coefficients is:

a₁\vec{x}₁+a₂\vec{x}₂+ . . . +aₙ\vec{x}ₙ (2)

Regression with Elastic Net

In some embodiments, the machine learning model of the AI prediction module 106d utilizes the Elastic Net regularized regression method that linearly combines the penalties for better accuracy. An exemplary Naïve Elastic Net methodology is described in Hui Zou and Trevor Hastie, “Regularization and variable selection via the elastic net,” J. R. Statist. Soc. Series B, vol. 67, pp. 301-320 (2005), which is incorporated herein by reference. The AI prediction module 106d applies the Elastic Net regression technique as follows in formulae (1)-(9):

Suppose that the trading data has n observations with p price predictors.

Let y={y₁, . . . , yₙ}^{T} be the response and X=(x₁| . . . |xₚ) be the model matrix, where xⱼ=(x₁, . . . , xₙⱼ)^{T}, j=1, . . . , p are the predictors.

After normalization, the AI prediction module 106d can assume that the response is centered and the predictors are standardized, as in:

Σᵢ₌₁ⁿyi (3)

Σᵢ₌₁ⁿxij (4)

Σᵢ₌₁ⁿxij2 (5)

for j=1, . . . , p.

Therefore, for any fixed non-negative λ1 and λ2, the AI prediction module 106d defines the naïve elastic net criterion L as:

$$L ( {λ}_{1} , {λ}_{2} , β ) = {\vert y - X β \vert}^{2} + {λ}_{2} {\sum }_{j = 1}^{p} {β}_{j}^{2} + {λ}_{1} {\sum }_{j = 1}^{p} \vert {β}_{j} \vert \qquad ( 6 )$$

The naïve elastic net estimator β is the minimizer of equation (6):

$$\begin{matrix}\hat{β} = {argmin}_{β} \{ L ( {λ}_{1} , {λ}_{2} , β ) \} \\ Let & ( 7 ) \\ α = {λ}_{2} / ( {λ}_{1} + {λ}_{2} ) & ( 8 )\end{matrix}$$

This procedure can be viewed as a penalized least squares method, with the function:

(1−α)|β|₁+α|β|² (9)

being called the elastic net penalty, which is a convex combination of the lasso and ridge penalty.

Elastic Net is particularly good at handling groups of co-relating features of high dimensions. Qualitatively speaking, a regression method exhibits the grouping effect if the regression coefficients of a group of highly correlated variables tend to be equal (up to a change of sign if negatively correlated). In events of proportionally identical variables, the regression method assigns identical coefficients to the identical variables. The Elastic Net produces a sparse model with good prediction accuracy, while encouraging a grouping effect. Of course, it should be appreciated that other regression techniques can be used within the context of the invention described herein.

### Evaluating Forecast Accuracy

A forecast “error” is the difference between an observed value and its forecast. Here, it should be appreciated that “error” does not mean a mistake, it means the unpredictable part of an observation. It can be written as:

e_{T+h}=y_{T+h}−ŷ_{T+h|T} (10)

where the training data is given by {y₁, . . . , y_{T}}, and the test data is given by {y_{T+1}, y_{T+2}, . . . }.

Note that forecast errors are different from residuals in two ways. First, residuals are calculated on the training set while forecast errors are calculated on the test set. Second, residuals are based on one-step forecasts while forecast errors can involve multi-step forecasts.

The AI prediction module 106d can measure forecast accuracy by summarizing the forecast errors in different ways. The module 106d uses median absolute deviation (MAD) to summarize forecast errors. MAD is a robust measure of the variability of a univariate sample of quantitative data. It is calculated on a univariate data set, denoted by X₁, X₂, . . . , Xₙ, where MAD is the median of the absolute deviations from the data's median:

MAD=median(|Xᵢ−median(X)|) (11)

The purpose of using median absolute deviation to summarize errors is to refine the machine learning algorithms to minimize the errors.

### Regularization

The AI prediction module 106d adds extra layers of machine learning model adjustments to improve algorithm accuracy. Regularization is a technique that applies to objective functions in ill-posed optimization problems. Generally, it is preferred to avoid large weights. A small change in weight makes a large difference in the target variable. Therefore, the AI prediction module 106d assigns zero weights for factors that are not important, and tries not to assign too much weight to any factor.

A regularization term (or regularizer) is added to a loss function which describes the cost of generating price predictions. Empirical learning of classifiers while learning from a finite data set is always an underdetermined problem, because in general they are trying to infer a function of any given only some examples.

It should be appreciated that a least absolute shrinkage and selection operator (LASSO) method is not used because LASSO makes bias-variance tradeoff by a continuous shrinkage. Therefore, LASSO does not work well in a group of highly correlated variables. In cross-blockchain trading scenarios, it is probable that certain events are correlated, e.g., the rise/drop of the BTC and ETH prices can be related. However, LASSO tends to select one variable from a group and ignore the others.

The Elastic Net used by the AI prediction module 106d (as described above) adds a quadratic part to the penalty, which is described in Tikhonov regularization (e.g., at en.wikipedia.org/wiki/Tikhonov_regularization, which is incorporated herein by reference). Using Elastic Net removes the limitation on the number of selected variables and encourages grouping effects.

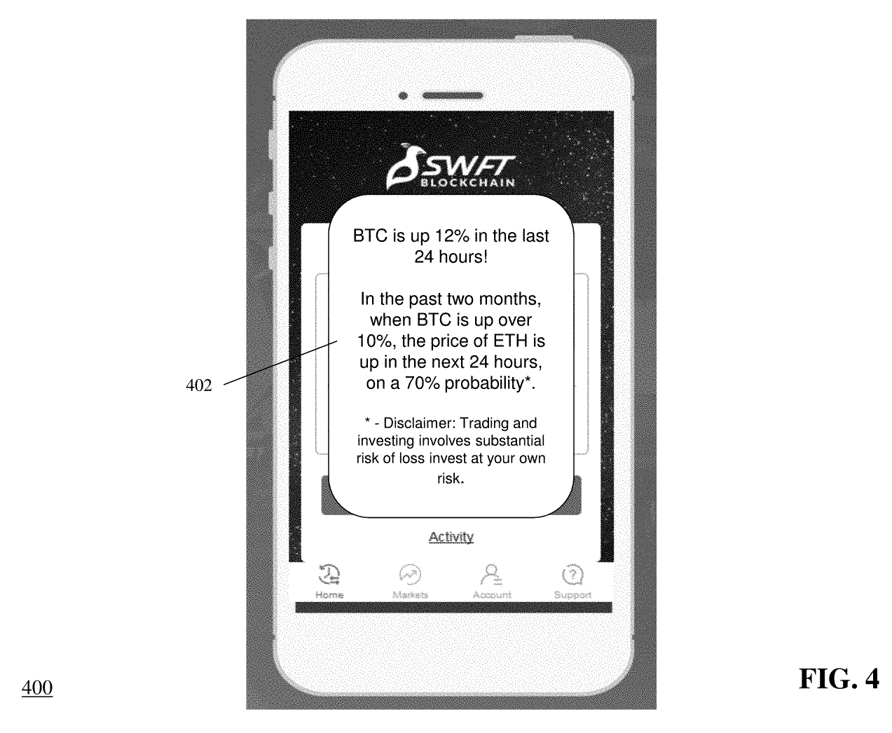

Once the AI prediction module 106d has analyzed the trading data as described herein, the module 106d can generate one or more predictions of future price changes for specific currencies and/or cryptocurrencies. For example, the AI prediction module 106d may determine that BTC is up 12% in the last twenty-four hours and in the past two months, when BTC is up over 10%, the price of ETH is up in the next twenty-four hours on a 70% probability. In this case, the AI prediction module 106d can generate a notification message that is transmitted back to one or more of the client computing devices 102a-102n. The app (or a browser) on the client computing devices 102a-102n can then display the notification message to the corresponding user. FIG. 4 is a diagram of an exemplary screenshot of a user interface 400 on the client computing device that includes a prediction notification message 402. In some embodiments, the notification message includes a link or button that instructs the user to click and immediately request the market price of one or more currencies and/or initiate a conversion for the subject currency.

Also, it should be appreciated that the prediction techniques described herein can leverage the Etherium Request for Comments (ERC)-20 token standard (e.g., as defined at theetherium.wiki/w/index.php/ERC20_Token_Standard) to better predict how various tokens (e.g., associated with initial coin offerings (ICOs), altcoins, and the like) will function within a larger blockchain/smart contract system, such as Etherium. ERC-20 defines specific functions and events that token contracts in Etherium have to implement, such as totalSupply( ), balanceOf( ), allowance( ), transfer( ), approve( ), transferFrom( ) functions and Transfer and Approval events. Because each of these tokens complies with the ERC-20 standard, the use of smart contracts to transfer such tokens is uniform and accessible and as such, the movement in token prices for many (if not all) of the tokens will rise and fall somewhat consistently with each other—which makes prediction of such prices easier and more efficient for the system described herein, resulting in consumption of less computing power and resources.

Turning back to FIGS. 2 and 3, once the cryptocurrency trading module 106e has identified a sequence of currency transactions that has an optimal value, the cryptocurrency trading module 106e executes (208) the identified sequence of currency transactions associated with the optimal value. For example, the user interface 300 of FIG. 3 will reflect the amount of the second currency that represents the optimal conversion (e.g., ETH 6.983664) and the user can select the ‘Start Exchange’ button to execute the sequence of currency transactions.

The following exemplary message depicts the sequence of currency transactions that has an optimal value as identified and encoded by the cryptocurrency trading module 106e (in a JSON format):

```
    {
        ‘exchange’: eg. hitbtc.com
        ‘market’: source and target, e.g., LTC -> BTC
        ‘amount’: in the volume of the source
        ‘price’: predefined price, if left unfilled, taking the
market price.
        ‘direction’: buy or sell
    }
```

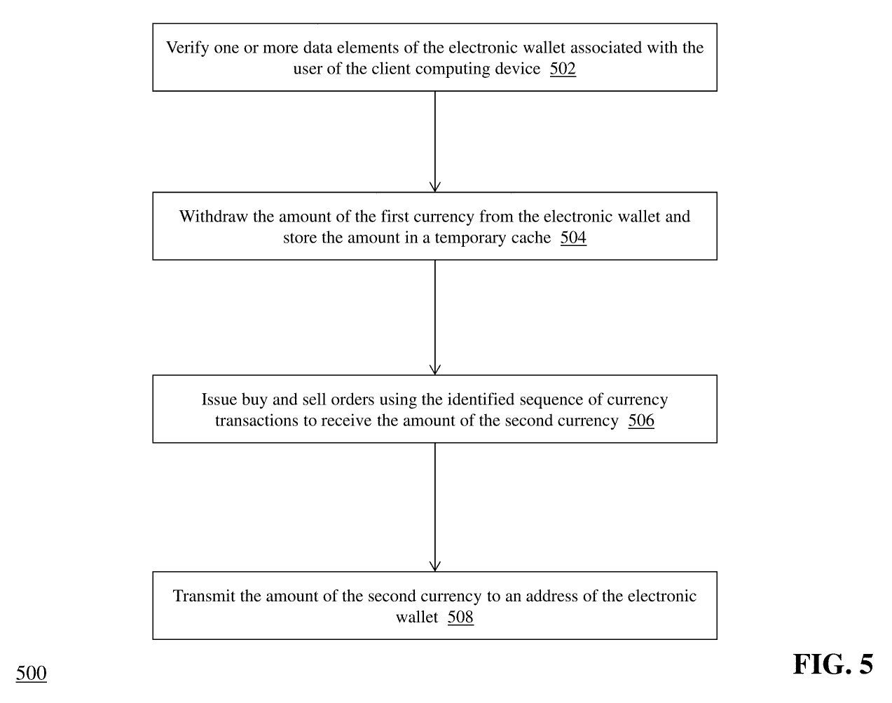

FIG. 5 is a flow diagram of a computerized method 500 of executing an identified sequence of currency transactions, using the system 100 of FIG. 1. The cryptocurrency trading module 106e of server computing device 106 verifies (502) one or more data elements of the electronic wallet associated with the user of the client computing device 102a. For example, the cryptocurrency trading module 106e can validate specific elements of the wallet such as: user account information (e.g., name, ID number, wallet address), user's cell phone number, two-step confirmation code, and the like. The module 106e can also verify that the user's electronic wallet has sufficient funds in the currency to be converted.

It should be appreciated that, in some embodiments, the cryptocurrency trading module 106e can use location information received from the client computing device (e.g., GPS coordinates and the like) to perform location-based trading verification—meaning that the module 106e can determine the user's geographic location and apply a set of trading rules that comply with local and/or national securities laws and regulations that govern trading in the specific location of the user. Because cryptocurrency/blockchain trading is intrinsically global, and can be anonymous (unlike traditional stock trading), the systems and methods described herein advantageously utilize location-based verification to add a layer of compliance and trust to the cryptocurrency trading process.

After verification is complete, the cryptocurrency trading module 106e withdraws (504) the amount of the first currency from the electronic wallet and stores the withdrawn amount in a temporary cache (e.g., in database 110). In some embodiments, the cryptocurrency trading module 106e also deducts any exchange fees (e.g., fee 306 in FIG. 3) from the user's wallet. The cryptocurrency trading module 106e then interfaces with the plurality of cryptocurrency exchanges associated with the sequence of currency transactions to issue (506) buy and sell orders to two or more of the plurality of cryptocurrency exchanges to receive the amount of the second currency and store the amount of second currency in the temporary cache. Once the sequence of transactions has been executed, the cryptocurrency trading module 106e transmits (508) the amount of the second currency to the address of the user's electronic wallet.

The following exemplary Python programming code represents a message generated by the cryptocurrency trading module 106e for converting GNT currency to DGD currency:

```
body: {
        “receiveCoinAmt”: “218.099616”,
        “receiveCoinCode”: “GNT”,
        “depositCoinCode”: “DGD”,
        “depositMin”: “0.01”,
        “minerFee”: “14.3184”,
        “depositMax”: “3.43312”,
        “depositCoinAmt”: “0.2”,
        “orderId”: “f0ab14c0-96cd-41b7-9a3b-b02b337f4b55”,
        “instantRate”: “1090.498081457433”
    }
    trade time: No. 0 !!
        order to fill: {‘coin_from’: ‘dgd’, ‘coin_to’: ‘gnt’,
‘amount’: 0.2, ‘est_ratio’: 1090.498081457433}
        sell orders: [{“exchange”: “binance”, “market”:
“dgd_btc”, “amount”: 0.2, “price”: 0.032153, “is_reverse?”:
false, “acc_amount”: 0.006430600000000001, “inter”: “btc”,
“status”: false, “request_times”: 0}]
        buy orders: [{“exchange”: “huobi_pro”, “market”:
“gnt_btc”, “amount”: 219.9247606019152, “price”: 2.924e−05,
“is_reverse?”: true, “acc_amount”: 0.006430600000000001,
“inter”: “btc”, “status”: false, “request_times”: 0}]
```

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Hyptertext Transfer Protocol Secure (HTTPS), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for conducting cross-blockchain currency transactions, the system comprising:
a server computing device including a memory for storing programmatic instructions and a processor for executing the programmatic instructions, and
a database coupled to the server computing device,
the processor of the server computing device executing the programmatic instructions to:
receive, from a first client computing device, a request for a conversion of an amount of a first currency listed for trading on at least one of a plurality of cryptocurrency exchanges to an amount of a second currency listed for trading on at least one of the plurality of cryptocurrency exchanges, the amount of at least one of the first currency or the second currency stored in an electronic wallet associated with a user of the first client computing device;
determine one or more sequences of currency transactions executable between two or more of the plurality of cryptocurrency exchanges that achieves the conversion from the amount of the first currency to the amount of the second currency, at least one of the one or more sequences of currency transactions comprising converting between cryptocurrencies operating on different blockchains;
identify one of the one or more sequences of currency transactions associated with an optimal value based upon one or more of: a market price of the first currency, a market price of the second currency, a latency associated with the sequence of currency transactions, or an exchange fee associated with one or more of the currency transactions in the sequence of currency transactions;
execute the identified sequence of currency transactions associated with the optimal value, comprising:
verifying one or more data elements of the electronic wallet associated with the user of the first client computing device;
withdrawing the amount of the first currency from the electronic wallet and storing the amount of the withdrawn first currency in a temporary cache of the database;
issuing buy and sell orders to two or more of the plurality of cryptocurrency exchanges using the identified sequence of currency transactions to receive the amount of the second currency and storing the amount of the second currency in the temporary cache; and
transmitting the amount of the second currency to an address of the electronic wallet associated with the user of the first client computing device.

2. The system of claim 1, wherein the first currency is a cryptocurrency and the second currency is a cryptocurrency.

3. The system of claim 1, wherein the first currency is a fiat currency and the second currency is a cryptocurrency.

4. The system of claim 1, wherein the first currency is a cryptocurrency and the second currency is a fiat currency.

5. The system of claim 1, wherein the first currency is a fiat currency and the second currency is a fiat currency.

6. The system of claim 1, wherein determining one or more sequences of currency transactions executable between two or more of the plurality of cryptocurrency exchanges comprises:
selecting a first cryptocurrency exchange of the plurality of cryptocurrency exchanges that lists the first currency for trading;
selecting a second cryptocurrency exchange of the plurality of cryptocurrency exchanges that lists the second currency for trading;
determining one or more intermediate cryptocurrency exchanges between the first cryptocurrency exchange and the second cryptocurrency exchange;
determining one or more intermediate cryptocurrencies between the first currency and the second currency that are listed for trading on one or more of the intermediate cryptocurrency exchanges; and
generating one or more sequences of currency transactions between the first cryptocurrency exchange and the second cryptocurrency exchange, at least one of the one or more sequences of currency transactions including sequences of currency transactions that involve at least one of the intermediate cryptocurrency exchanges and at least one of the intermediate cryptocurrencies.

7. The system of claim 1, wherein identifying one of the one or more sequences of currency transactions associated with an optimal value comprises one or more of: identifying a sequence of currency transactions that has a highest price of the first currency, identifying a sequence of currency transactions that has a lowest price of the second currency, identifying a sequence of currency transactions that has a lowest exchange fee associated with one or more of the currency transactions, or identifying a sequence of currency transactions that completes within the latency.

8. The system of claim 1, wherein verifying one or more data elements of the electronic wallet associated with the user of the first client computing device comprises validating availability of the amount of the first currency in the electronic wallet.

9. The system of claim 1, wherein verifying one or more data elements of the electronic wallet associated with the user of the first client computing device comprises validating an identifier associated with the first client computing device.

10. The system of claim 9, wherein the identifier is a cell phone number.

11. The system of claim 1, wherein withdrawing the amount of the first currency from the electronic wallet and storing the amount of the withdrawn first currency in a temporary cache of the database comprises adding a transaction entry to a blockchain associated with the first currency, the transaction comprising the amount of the first currency and an address of the electronic wallet.

12. The system of claim 1, wherein transmitting the amount of the second currency to an address of the electronic wallet associated with the user of the first client computing device comprises adding a transaction entry to a blockchain associated with the second currency, the transaction comprising the amount of the second currency and the address of the electronic wallet.

13. A computerized method of conducting cross-blockchain currency transactions, the method comprising:
receiving, by a server computing device from a first client computing device, a request for a conversion of an amount of a first currency listed for trading on at least one of a plurality of cryptocurrency exchanges to an amount of a second currency listed for trading on at least one of the plurality of cryptocurrency exchanges, the amount of at least one of the first currency or the second currency stored in an electronic wallet associated with a user of the first client computing device;
determining, by the server computing device, one or more sequences of currency transactions executable between two or more of the plurality of cryptocurrency exchanges that achieves the conversion from the amount of the first currency to the amount of the second currency, at least one of the one or more sequences of currency transactions comprising converting between cryptocurrencies operating on different blockchains;
identifying, by the server computing device, one of the one or more sequences of currency transactions associated with an optimal value based upon one or more of: a market price of the first currency, a market price of the second currency, a latency associated with the sequence of currency transactions, or an exchange fee associated with one or more of the currency transactions in the sequence of currency transactions;
executing, by the server computing device, the identified sequence of currency transactions associated with the optimal value, comprising:
verifying one or more data elements of the electronic wallet associated with the user of the first client computing device;
withdrawing the amount of the first currency from the electronic wallet and storing the amount of the withdrawn first currency in a temporary cache of the database;
issuing buy and sell orders to two or more of the plurality of cryptocurrency exchanges using the identified sequence of currency transactions to receive the amount of the second currency and storing the amount of the second currency in the temporary cache; and
transmitting the amount of the second currency to an address of the electronic wallet associated with the user of the first client computing device.

14. The method of claim 13, wherein the first currency is a cryptocurrency and the second currency is a cryptocurrency.

15. The method of claim 13, wherein the first currency is a fiat currency and the second currency is a cryptocurrency.

16. The method of claim 13, wherein the first currency is a cryptocurrency and the second currency is a fiat currency.

17. The method of claim 13, wherein the first currency is a cryptocurrency and the second currency is a fiat currency.

18. The method of claim 13, wherein determining one or more sequences of currency transactions executable between two or more of the plurality of cryptocurrency exchanges comprises:
selecting a first cryptocurrency exchange of the plurality of cryptocurrency exchanges that lists the first currency for trading;
selecting a second cryptocurrency exchange of the plurality of cryptocurrency exchanges that lists the second currency for trading;
determining one or more intermediate cryptocurrency exchanges between the first cryptocurrency exchange and the second cryptocurrency exchange;
determining one or more intermediate cryptocurrencies between the first currency and the second currency that are listed for trading on one or more of the intermediate cryptocurrency exchanges; and
generating one or more sequences of currency transactions between the first cryptocurrency exchange and the second cryptocurrency exchange, at least one of the one or more sequences of currency transactions including sequences of currency transactions that involve at least one of the intermediate cryptocurrency exchanges and at least one of the intermediate cryptocurrencies.

19. The method of claim 13, wherein identifying one of the one or more sequences of currency transactions associated with an optimal value comprises one or more of: identifying a sequence of currency transactions that has a highest price of the first currency, identifying a sequence of currency transactions that has a highest price of the second currency, identifying a sequence of currency transactions that has a lowest exchange fee associated with one or more of the currency transactions, or identifying a sequence of currency transactions that completes within the latency.

20. The method of claim 13, wherein verifying one or more data elements of the electronic wallet associated with the user of the first client computing device comprises validating availability of the amount of the first currency in the electronic wallet.

21. The method of claim 13, wherein verifying one or more data elements of the electronic wallet associated with the user of the first client computing device comprises validating an identifier associated with the first client computing device.

22. The method of claim 21, wherein the identifier is a cell phone number.

23. The method of claim 13, wherein withdrawing the amount of the first currency from the electronic wallet and storing the amount of the withdrawn first currency in a temporary cache of the database comprises adding a transaction entry to a blockchain associated with the first currency, the transaction comprising the amount of the first currency and an address of the electronic wallet.

24. The method of claim 13, wherein transmitting the amount of the second currency to an address of the electronic wallet associated with the user of the first client computing device comprises adding a transaction entry to a blockchain associated with the second currency, the transaction comprising the amount of the second currency and the address of the electronic wallet.
